(19) United States
(12) Patent Application Publication
(10) Pub. No.: US 2014/0099890 A1
(43) Pub. Date: Apr. 10, 2014

(54) WIRELESS PLATFORM FOR ROTARY JOINT

(71) Applicant: Deublin Company, Waukegan, IL (US)

(72) Inventors: Jerry A. Lichter, Burlington, WI (US); Donald Louis Deubler, Lake Forest, IL (US); Erich Loacker, Lake Forest, IL (US)

(73) Assignee: Deublin Company, Waukegan, IL (US)

(21) Appl. No.: 14/051,048

(22) Filed: Oct. 10, 2013

Related U.S. Application Data
(60) Provisional application No. 61/711,980, filed on Oct. 10, 2012.

(51) Int. Cl. H04B 5/00

(52) U.S. Cl. CPC H04B 5/0031
USPC 455/41.1

(57) ABSTRACT

A rotary joint is provided. The rotary joint includes a stator and a rotor. The stator includes a stator housing, a first wireless communication platform device having a first wireless communication module connected to a plurality of data signal lines of the stator and at least one power line of the stator, and a first antenna. The rotor is configured to be actuated in a rotational manner relative to the stator, and the rotor includes a rotor housing, a second wireless communication platform device comprising a second wireless communication module connected to a plurality of data signal lines of the rotor and at least one power line of the rotor, and a second antenna. The first wireless communication platform device and the second wireless communication platform device are configured to communicate operational data with one another via the first and second antennas.

### CROSS-REFERENCE TO RELATED APPLICATIONS

This patent application claims the benefit of U.S. Provisional Patent Application No. 61/711,980, filed Oct. 10, 2012, which is incorporated by reference.

### BACKGROUND

In a variety of technological contexts, machines need to collect information for proper decision-making based on corresponding control logic. For example, sensors such as temperature, speed, pressure, and other signal detectors can send information to a control unit of the machine, and the control unit responds to the signals it receives by making adjustments—e.g., regulating speed, adjusting pressure or pitch, etc. Video information is also an example of data that is collected and sent for decision making processes based on character recognition, process changes, product condition and other video analysis.

Complications are introduced when the transmission of such signals must be made between static and dynamic components, particularly where rotational motion is associated with the dynamic components. Conventional systems generally use sliding contacts in slip rings to transmit signal information and power across rotary joints involving a static or stationary component and a rotational dynamic component, but conventional slip rings generally have short lifetimes, are susceptible to interference and are complex, expensive, and/or difficult to maintain.

Conventional slip rings can be classified into two different types: contact and non-contact slip rings. Contact-type slip rings include traditional monofilament wire brush slip rings and traditional composite graphite based brush slip rings. Both have a number of disadvantages, including limited frequency range, short brush life due to frictional and arc wear, difficult assembly, and brush dust generation that requires periodic cleaning. Other less common contacting methods include mercury, flexible rings and conductive grease which, similar to other conventional contact slip rings, also have wear issues.

Non-contact-type slip rings include optical, capacitive, and inductive joints. While the non-contact-type slip rings avoid some of the disadvantages associated with using brushes such as wear, they have several disadvantages of their own.

Optical rotary joints are complex to install and repair due to the stringent requirements associated with optical cables, have expensive light sources and electronic drivers for transmitting and receiving fiber signals, and require application-specific cables (they need to match the wavelength being used to the cable being used). Multiple channel optical rotary joints have high losses, which limit usage to applications that can accept lower light levels. The specialized installation methods, troubleshooting methods and personnel along with higher cost make optical rotary joints viable only for particular applications.

Rotary joints using capacitive and inductive coupling have relatively narrow frequency bands, require complex data formatting circuitry, stringent control of capacitive gap variation, and raise concerns regarding data loss. Circuit design on each side of the coupling capacitor for the capacitively-coupled model is complicated due to RC time constants and resonant frequencies set up between the signal paths and the coupling capacitor, and thus it is impractical to implement rotary joints using capacitive and inductive couplings for many applications.

Coaxial, radiofrequency (RF) rotary joints (in many cases special examples of capacitively-coupled rotary joints) have stringent requirements with respect to dimensional characteristics in order to maintain signal integrity, have high material cost, and have high assembly costs and difficult assembly processes due to tight tolerances. Coaxial and RF rotary joints are also only viable for particular applications due to these high costs and specialized assembly. Using infrared (IR) technology for transmission across rotary joints suffers from similar problems, with line-of-sight issues or other interference issues that require specialized configurations to address.

### SUMMARY

In an embodiment, the invention provides a wireless platform for a rotary joint that overcomes the aforementioned disadvantages of the prior art. In the static and the dynamic sections of the rotary joint, an antenna, a wireless communications module, and a signal converter are provided to facilitate the communication of data signals across the rotary joint without the need for a contacting, optical, coaxial, RF, IR, capacitive, or inductive connection for the data signals. The wireless communication modules and the antennas provide a wireless connection between the static and dynamic sections of the rotary joint utilizing any short-range wireless protocols, such as Wi-Fi, Zigbee, Bluetooth, wireless HDMI and/or IEEE 802.11 protocols. The signal converters transform various incoming/outgoing signals to/from the wireless protocol for transmission via the wireless connection. Thus, the rotary joint utilizing the wireless platform is able to achieve improved reliability and scalability with respect to data transmission, and to achieve easier assembly and a compact size, while also providing compatibility with multiple protocols and significantly reducing costs. The electronic circuitry is contained within an electrically shielded enclosure. The shielded enclosure minimizes EMI effects from outside the enclosure (which may affect the operation of the data transfer) and minimizes the EMI generated by data transfer within the enclosure from leaving the enclosure. The short range transmission and containing the entire circuitry and transmission within the relatively small electrically shielded enclosure makes this solution particularly advantageous.

It will be appreciated that power is transferred between the two sections of the rotary joint through any conventional contact or non-contact technology for power transmission, and that the two sections of the rotary joint may further include a voltage converter for extracting the appropriate power into the system on either side of the rotary joint. An alternative to transferring power between the two sections would be to have or utilize power within each section such as battery power or utilizing an existing power source within each section.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a block diagram depicting connections and components of the wireless platform for the static or dynamic components of a rotary joint according to an exemplary embodiment;

FIG. 2 depicts an example of a conventional rotary joint;

FIGS. 3 and 4 depict the static and dynamic components of the conventional rotary joint shown in FIG. 2; and

FIG. 5 depicts an exemplary configuration of the wireless communication components of the wireless platform in a rotary joint; and

FIG. 6 depicts an alternate exemplary configuration of the wireless communication components of the wireless platform in a rotary joint.

### DETAILED DESCRIPTION

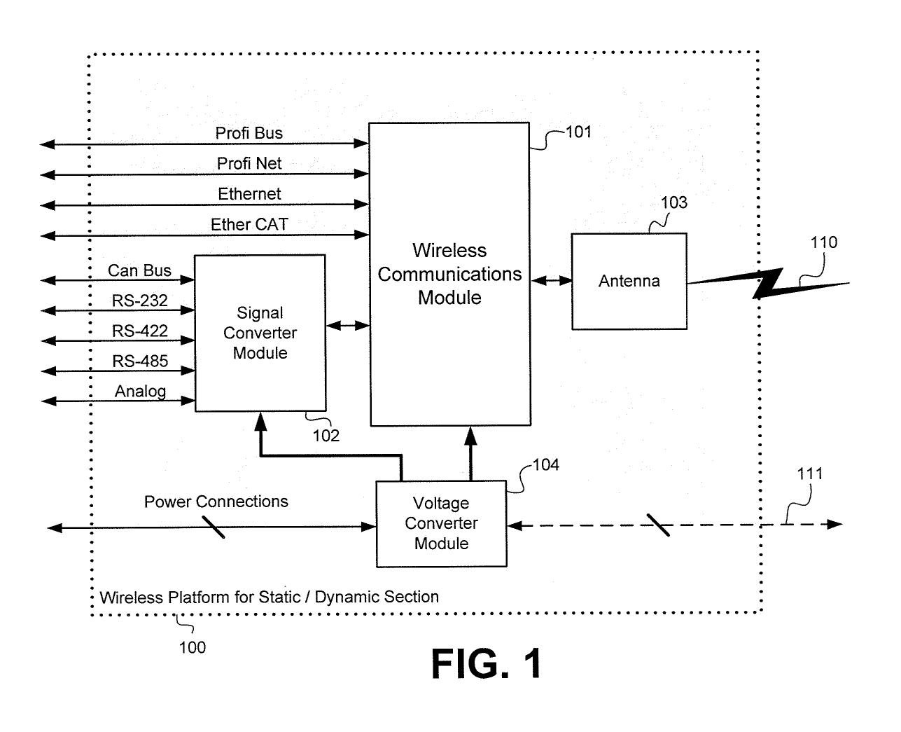

FIG. 1 provides a block diagram of an exemplary implementation of a wireless platform according to the principles of the present invention in a static or dynamic section of a rotary joint. Each of the static and dynamic sections of the rotary joint includes a wireless communication module 101, a signal converter module 102, an antenna 103, and a voltage converter module 104. Additionally, a shield (not pictured) may be placed around the components of the wireless platform to shield the components from outside interference (while still allowing for transmission between the static and dynamic sections).

The wireless communications module 101 comprises wireless communications hardware (e.g., a printed circuit board) used for generating short-range wireless communication signals according to a protocol such as Wi-Fi, Zigbee, Bluetooth, wireless HDMI and/or the IEEE 802.11 standard. These short-range wireless communication signals are transmitted and received through the antenna 103, via a wireless connection 110, to and from the other section of the rotary joint—i.e., between the static and dynamic sections of the rotary joint.

Certain signal connections from the system connected to the rotary joint feed directly into the wireless communications module 101, such as Ethernet, EtherCAT, Profinet, and Profibus connections. Other signal connections, such as Can Bus, RS-232, RS-422, RS-485, video, optical and analog signal connections, feed into a signal converter module 102, which conforms the signals to a format compatible with the wireless communication module 101 (e.g., an Ethernet format) and transmits the converted signals to the wireless communication module 101. It will be appreciated that signal communications may not only be transmitted via the antenna, but also received through the antenna and processed by the wireless platform—i.e., Ethernet signals received via antenna 103 and wireless communication module 101 may be converted to appropriate non-Ethernet formats by the signal converter module 102 and sent to the system along the Can Bus, RS-232, RS-422, RS-485, video, optical and/or analog signal connections, or not converted and sent to the system along the Ethernet, EtherCAT, Profinet, and/or Profibus connections.

It will further be appreciated that the above described types of signal connections—i.e., Ethernet, EtherCAT, Profinet, Profibus, Can Bus, RS-232, RS-422, RS-485, video, optical and analog—are merely examples of some common types of signal connections, and that one skilled in the art would understand that other types of signal connections may be used as well (with or without the signal converter module 102). Moreover, one skilled in the art would be able to implement variations of the exemplary configuration shown in FIG. 1 without departing from the inventive principles of the presently disclosed invention. For example, the signal converter module 102 could be divided into separate signal converter modules for each type of signal, or the signal converter module and associated connection lines could be integrated with the Ethernet, EtherCAT, Profinet, and/or Profibus connection lines via a multiplexer circuit to multiplex all signals transmitted to and received from the wireless communication module 101. In another exemplary further embodiment, multiple wireless communication modules could be used or separate circuit boards could be stacked together to form the wireless communication module to accommodate varying bandwidth requirements. Because of the symmetry of the circuitry, either portion could be stationary and the other portion could be rotatable.

In various exemplary embodiments, the wireless communication module 101 is a WiFi transceiver, a wireless Ethernet bridge or a custom-designed wireless module, and the signal converter module 102 is a digital parallel-to-serial converter, RS422-to-Ethernet converter, or a more custom approach to the conversion.

The exemplary wireless platform 100 of FIG. 1 further depicts an antenna 103 connected to the wireless communication module 101 for facilitating communications between the two sections of the wireless platform 100. In an exemplary embodiment, the antenna 103 is a wire of an appropriate length based on the wavelength of the frequency of the wireless communication module 101. In other exemplary embodiments, the antenna 103 has a relatively more complex antenna shape designed to optimize distance, position and the cavity shape used to house this assembly.

The exemplary wireless platform 100 of FIG. 1 further depicts a voltage converter 104. The voltage converter 104 may be used to extract the appropriate power for the system on either side of the rotary joint, and is further used to provide power to the wireless communications module 101 and the signal converter module 102. The voltage converter 104 is connected to the system through a plurality of power connections, which may include a number of power lines associated with various control devices and functional modules of the system, as well as lines corresponding to interlocks and an emergency stop button. Further the voltage converter 104 is connected to the other section of the rotary joint through a power connection 111, which may be implemented using conventional contact (e.g., brushes), inductively coupled non-contact or capacitively coupled non-contacting technologies.

In an exemplary embodiment, the voltage converter module 104 is a DC power supply that converts from an AC power to the required DC power. In another exemplary embodiment, the voltage converter module 104 is a converter to raise (boost) or lower (buck) the DC voltage from the incoming voltage to the required voltage for the wireless communication modules and signal converter modules.

It will be appreciated that all of the modules 101, 102, 103, and 104 discussed above may be implemented as integrated circuits (ICs) with the appropriate discrete support components.

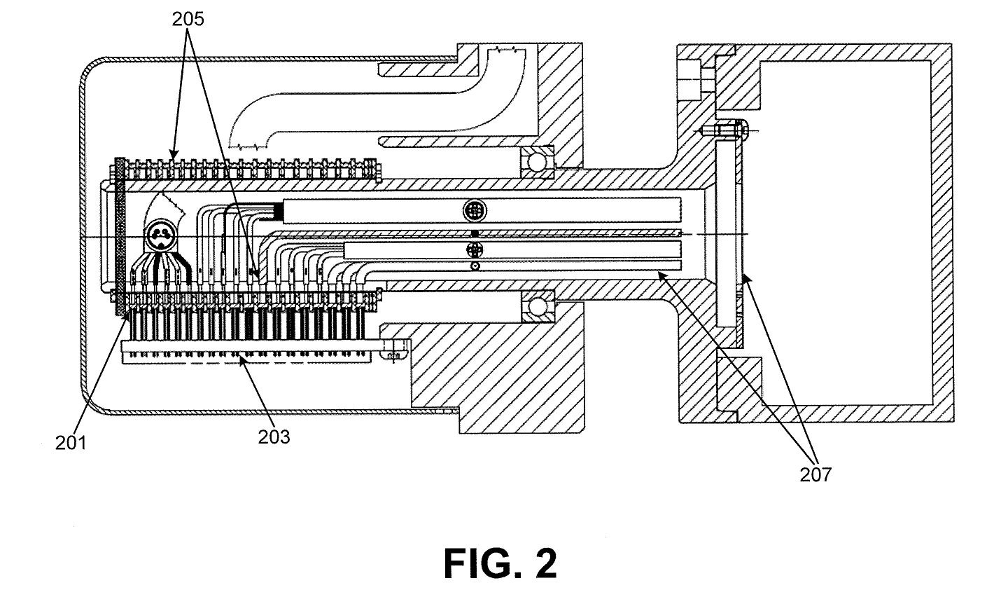

With further reference to the exemplary wireless platform architecture depicted by FIG. 1, FIGS. 2-6 depict examples of how the wireless platform 100 can be incorporated into an exemplary rotary joint.

FIG. 2 depicts an example of a conventional rotary joint utilizing a traditional brushed connection for transmission of data signals. Element 201 points to the sliding contact between conductor rings of the rotor and the brushes of the stator in the conventional rotary joint through which data is transmitted. In an exemplary embodiment, element 201 is eliminated because the data transmission is accomplished through wireless connection 110 (FIG. 1).

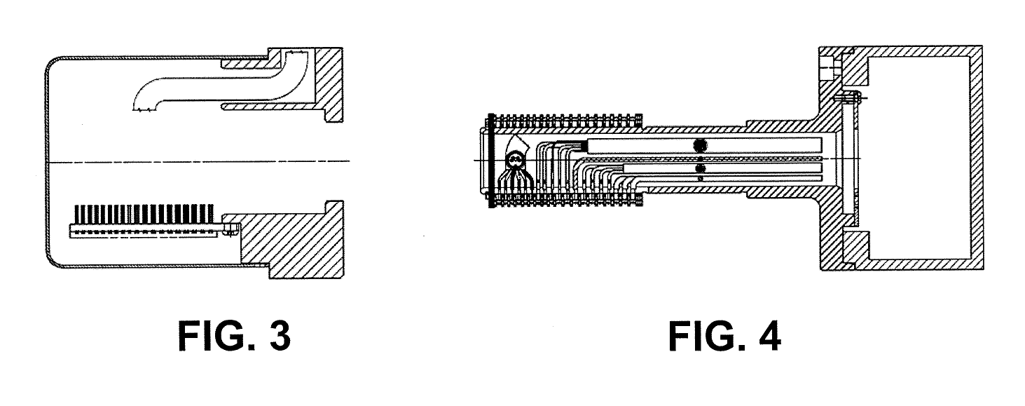

Element 203 points to the brushes and the brush holder in the stator of the conventional rotary joint. Element 205 points to the conductor rings and connections to the conductor rings in the rotor of the conventional rotary joint, and element 207 points to connections and wires in the rotor of the conventional rotary joint. In an exemplary embodiment of the invention, element 203 is eliminated because the wireless antenna 101 and wireless communications module 110 (FIG. 1) of the stator section provide the components of the stator through which data is transmitted. Similarly, elements 205 and 207 are eliminated because the wireless antenna 101 and wireless communications module 110 (FIG. 1) of the rotor section provide the components of the rotor through which data is transmitted. For clarity, FIGS. 3 and 4 provide separate views of the static or stationary component, i.e., the stator (FIG. 3), and the dynamic or rotational component, i.e., the rotor (FIG. 4), of the conventional rotary joint depicted in FIG. 2.

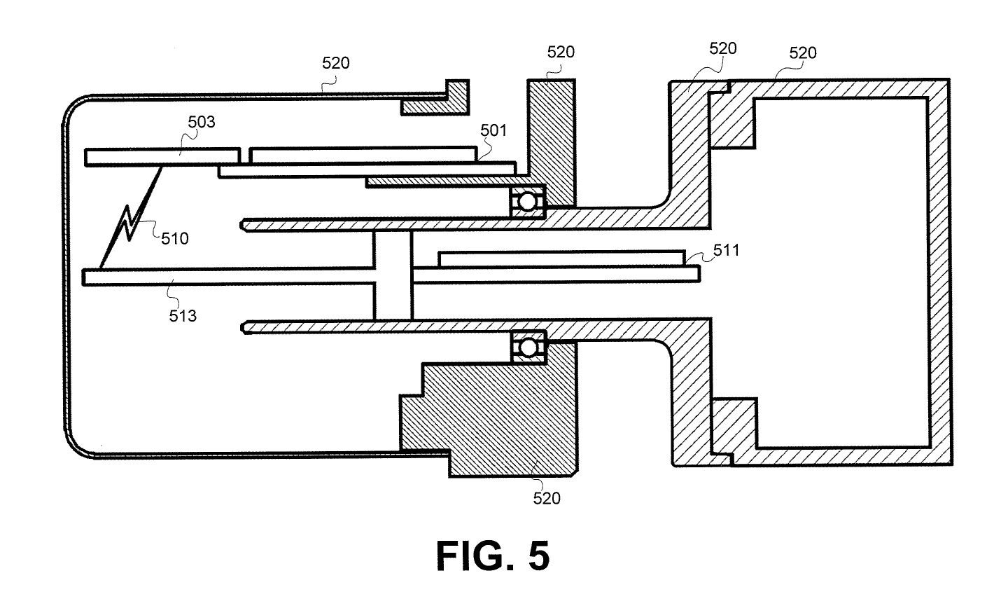

FIG. 5 shows an exemplary embodiment of the invention where the brushed interface of a conventional rotary joint for communication of data signals between the static component and the rotational component of the rotary joint is eliminated. In the stator, a stator wireless communication platform device 501 (including a wireless communication module, a signal converter module, and a voltage converter module) is affixed to a section of the stator housing, with a stator antenna 503 being connected to the stator wireless communication module 501. The stator antenna 503 communicates across wireless connection 510 with a rotor antenna 513. In this exemplary embodiment, the rotor antenna 513 is positioned along a central axis of the rotor such that rotation of the rotor causes only rotational motion (and not translational motion) in the rotor antenna 513. The rotor antenna 513 is attached to a section of the rotor housing and is connected to a rotor wireless communication platform device 511 (including a wireless communication module, a signal converter module, and a voltage converter module). Additionally, the housings for the stator and the rotor include EMI shielding 520 that shields the components of the stator and rotor from outside interference.

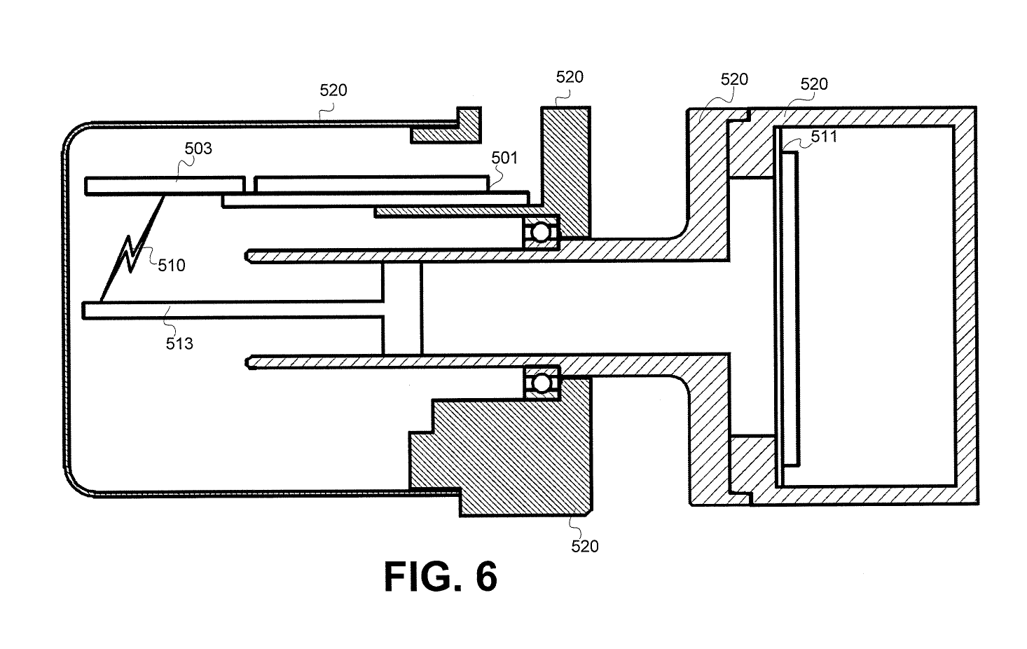

In FIG. 6, an alternative example is depicted for the configuration of the rotational component of the rotary joint where the wireless communication platform device 511 is positioned at a location separate from the rotor antenna 513. The wireless communication platform device 511 communicates with the rotor antenna 513 via a wired connection within the rotor.

It will be appreciated that, in various embodiments, antenna location depends on the antenna design, antenna radiation pattern, and gain/attenuation required by the corresponding wireless communication module. Antenna placement is provided such that an appropriate level of data signals is maintained during transmission between the two antennas.

It will further be appreciated that the antennas and the wireless communication modules of the stator and rotor need not be provided in the precise positions as depicted in FIGS. 5-6, and that other configurations are possible without departing from the principles of the invention. In an embodiment, the components of the wireless platform are implemented as discrete device package, one for the stator and one for the rotor, configured to interface with the corresponding data buses and power buses of the stator and the rotor, such that the wireless platform device packages are attachable and detachable within the stator and the rotor and adapted to be affixed to multiple different positions within the stator and/or the rotor.

It will thus be appreciated that the described principles provide a wireless platform for a rotary joint that allows improved reliability and scalability with respect to data transmission, easier assembly, and compact size, while also providing compatibility with multiple protocols and significantly reducing costs. In various embodiments, the wireless platform may be incorporated into the rotary joints used in a variety of different applications. For example:
Wind Turbines—Blades can be pitched either hydraulically or electrically. In the case of hydraulic pitch, an electrical rotary joint is attached to the union to help with critical sensor or control data. In electrical pitch, similar sensors are used with an electrical rotary joint, but without the union.
Transfer Lines/Work Holding—this is also known as rotary or index table applications where unions and electrical rotary joints are combined to send fluids, power and/or signals to devices on the rotating table. These indexing tables typically turn 90 to 180 degrees at a time and usually go through a full rotation to complete a cycle of work on parts, and are most commonly found in auto and aerospace factories.
Chemical Mechanical Polishers (CMP)—used in silicon wafer fabrication, the chemical mechanical polishing process is used to prepare the wafer for many of its next steps in production. Unions are provided below the platen (the surface the wafer is polished on) to allow for water to pass into the jacketed table to provide cooling. It is essential in this process to maintain a constant temperature within very tight limits. Temperature of the wafer is regulated by cooling water in the table, and the speed of the polishing. In addition to the union, CMP's usually have an electrical rotary joint that is transferring thermocouple data from the table to the control system. The control system uses this temperature data to know whether to add more water, slow down, speed up, or control other parameters to allow for the wafer to be processed.
Satellite Communications Unit—on a mobile satellite communications unit there can be up to three rotary units connected in tandem. An RF coaxial joint that is sending the actual communications signal, an electrical rotary joint that is sending power and signals for the mechanical unit itself, and a fluid rotating union that is providing cooling water or air to the power amplifier mounted on the back of the dish.

It will be appreciated that the foregoing methods and implementations are merely examples of the inventive principles, and that these illustrate only preferred techniques.

The use of the terms “a” and “an” and “the” and “at least one” and similar referents in the context of describing the invention are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter as permitted by applicable law. Moreover, any combination of the above-described elements in all possible variations thereof is encompassed by the invention unless otherwise indicated herein or otherwise clearly contradicted by context.

1. A rotary joint, comprising:
a stator, comprising: a stator housing, a first wireless communication platform device comprising a first wireless communication module connected to a plurality of data signal lines of the stator and at least one power line of the stator, and a first antenna; and
a rotor, configured to be actuated in a rotational manner relative to the stator, the rotor comprising: a rotor housing, a second wireless communication platform device comprising a second wireless communication module connected to a plurality of data signal lines of the rotor and at least one power line of the rotor, and a second antenna;
wherein the first wireless communication platform device and the second wireless communication platform device are configured to communicate operational data with one another via the first and second antennas.

2. The rotary joint of claim 1, wherein the first wireless communication module is connected to the plurality of data signal lines of the stator via a first signal converter module, and the second transceiver is connected to the plurality of data signal lines of the rotor via a second signal converter module.

3. The rotary joint of claim 2, wherein the first and second signal converter modules each include input interfaces for Can Bus, RS-232, RS-422, and RS-485 signals.

4. The rotary joint of claim 1, wherein the first and second wireless communication modules are WiFi transceivers.

5. The rotary joint of claim 1, wherein the first wireless communication module is connected to the at least one power line of the stator via a first voltage converter module, and the second wireless communication module is connected to the at least one power line of the rotor via a second voltage converter module.

6. The rotary joint of claim 1, wherein the first wireless communication platform devices is detachable and configured to be affixed to different positions within the stator.

7. The rotary joint of claim 1, wherein the second wireless communication platform devices is detachable and configured to be affixed to different positions within the rotor.

8. The rotary joint of claim 1, wherein the stator housing and rotor housing include electromagnetic interference (EMI) shielding.

9. The rotary joint of claim 1, wherein the second antenna is positioned in line with a rotational axis of the rotor.

10. The rotary joint of claim 1, wherein the first and second wireless communication modules each include input interfaces for Profi Bus, Profi Net, Ethernet, and Ether CAT signals.

11. A wireless platform communication device for one of a rotor and a stator of a rotary joint, configured to communicate with another wireless platform communication device in the other of the rotor and a stator of the rotary joint via an antenna connected to the wireless platform communication device, the wireless platform communication device comprising:
a wireless communication module, connected to the antenna, connected to a plurality of data signal lines via a signal converter module, and connected to at least one power line via a voltage converter module;
the signal converter module, having interfaces for each of the plurality of data signal lines and an interface with the wireless communications module;
the voltage converter module, having at least one interface corresponding to the at least one power line and an interface with the wireless communications module.

12. The wireless platform communication device of claim 11, wherein the plurality of data signal lines include Can Bus, RS-232, RS-422, and RS-485 data signal lines.

13. The wireless platform communication device of claim 11, wherein the wireless communication module includes input interfaces for Profi Bus, Profi Net, Ethernet, and Ether CAT signals.

14. The wireless platform communication device of claim 11, wherein the wireless platform communication device is detachable and configured to be affixed to different positions within the one of the stator and the rotor.

15. The wireless platform communication device of claim 11, wherein the wireless platform communication device is shielded by electromagnetic interference (EMI) shielding integrated in the one of the stator and the rotor.
